(19) United States
(12) Patent Application Publication
(10) Pub. No.: US 2011/0006703 A1
(43) Pub. Date: Jan. 13, 2011

(54) Light emitting diode illumination device and method for controlling electric current

(76) Inventors: Meng-Chai Wu, Hsinchu (TW); Hua-Lung Tzou, Hsinchu (TW); Chun-Kai Hsu, Hsinchu (TW)

Correspondence Address: Jackson Intellectual Property Group PLLC, 106 Starvale Lane, Shipman, VA, 22971, US

(21) Appl. No.: 12/830,633

(22) Filed: Jul. 6, 2010

(30) Foreign Application Priority Data
Jul. 9, 2009 (TW) 098123213

(51) Int. Cl. H05B 37/02

(52) U.S. Cl. 315/294

(57) ABSTRACT

A light emitting diode (LED) illumination device utilizes a power transmission line to electrically connect a driving module and at least one LED lamp body. The driving module outputs a high frequency alternating power having above 30 voltages and above 72 Hz frequencies through frequency modulation. Each LED lamp body has at least one LED element and a rectification module. The high frequency alternating power generated from the driving module is modulated by the rectification module into a direct power to drive the LED element. Accordingly, the flicker phenomenon on the light source can be effectively improved, and the filter component installed inside each LED lamp body can be omitted. A simple circuit is used to reliably drive the LED element to achieve goals of rapidly developing products and saving costs.

### BACKGROUND OF THE INVENTION

1. Field of the Invention

The present invention relates to a light emitting diode illumination device and a method for controlling currents.

2. Description of the Related Art

A light emitting diode (LED) is solid-operated and unlike conventional fluorescent lamp tubes or incandescent lamp bulbs that may be damaged due to gas or vacuum tubes. Further, since the LED has properties of resisting vibrations, swing and abrasion, the service life can be effectively increased. When the value of the LED products is greatly improved, the field of high brightness LED is continuously developed. For illumination markets, the conventional fluorescent lamp tubes or incandescent lamp bulbs will be gradually replaced with the high brightness LEDs that are applied to flashlights, searchlights, camp lights, photo flash light, medical lamps or outdoor lighting.

Moreover, modular LED elements have been presented to the public. People can conveniently install and arrange uncertain amount of the LED elements to form a LED lamp body with a lamp strip, an array-shaped or a disc-shaped, thereby providing an illumination light source for related products. In addition, conventional control circuit architecture of driving a LED illumination device adopts direct current driving mode or alternating current to convert into a direct power for driving through rectifier/filter components. However, the former manner is too complicated while converting alternating current into direct current; the latter manner may obtain high voltages. The high voltages may cause dangers, and the capacitor for filtering may have the problem of service life.

Further, driving circuits are usually installed inside the LED lamp bodies of the conventional LED illumination devices. If a capacitor is not used to filter rectified alternating current, discontinuous electric current will generate the flicker phenomenon on the light source due to Vf. Therefore, the capacitor for filtering is installed inside the LED lamp body to cause more complicated circuit architecture in the whole LED lamp body. Consequently, the speed of developing products may be influenced, and the whole LED lamp body is unable to be normally operated due to damaged capacitors.

### SUMMARY OF THE INVENTION

In view of the shortcomings of the prior art, the inventor of the present invention based on years of experience in the related industry to conduct extensive researches and experiments, and finally developed a light emitting diode (LED) illumination device and a method for controlling current.

Therefore, it is a primary objective of the present invention to overcome the aforementioned shortcoming and deficiency of the prior art by providing light emitting diode illumination device capable of effectively improving the flicker phenomenon on the light source and omitting the filter component installed inside each LED lamp body and a method for controlling current.

To achieve the foregoing objective, the LED illumination device of the present invention comprises a driving module, at least one LED lamp body and at least one power transmission line. The power transmission line is used to electrically connect the driving module and the LED lamp body. The driving module outputs a high frequency alternating power having above 30 voltages and above 72 Hz frequencies through frequency modulation. Each LED lamp body has at least one LED element and a rectification module. The high frequency alternating power generated from the driving module is modulated by the rectification module into a direct power to drive the LED element for operation.

Accordingly, the flicker phenomenon on the light source can be effectively improved by increasing frequencies, and the filter component installed inside each LED lamp body can be omitted. More specifically, a simple circuit is used to reliably drive the LED element to achieve goals of rapidly developing products and saving costs.

### BRIEF DESCRIPTION OF THE DRAWINGS

FIG. 1 is a block diagram of a basic architecture of a light emitting diode (LED) illumination device according to a first embodiment of the present invention;

FIG. 2 is a block diagram of a basic architecture of a driving module according to the present invention;

FIG. 3 is a schematic diagram of power transmission between a driving module and a LED lamp body according to the present invention;

FIG. 4 is a block diagram of a basic architecture of a LED illumination device according to a second embodiment of the present invention;

FIG. 5 is a block diagram of a basic architecture of a LED illumination device according to a third embodiment of the present invention;

FIG. 6 is a wave form diagram of transmission between a LED element and a driving module according to the present invention; and

FIG. 7 is a table of comparing wire consumption under different transmitted voltages by taking 100 W/20 meter as an example.

### DETAILED DESCRIPTION OF THE PREFERRED EMBODIMENTS

The foregoing and other technical characteristics of the present invention will become apparent with the detailed description of the preferred embodiments and the illustration of the related drawings.

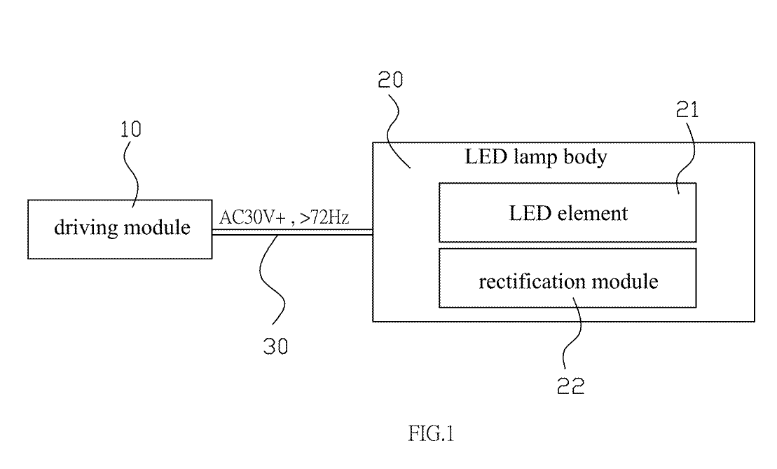

The objective of the present invention is to provide a LED illumination device capable of effectively improving the flicker phenomenon on the light source and omitting the filter component installed inside each LED lamp body and a method for controlling current. As shown in FIG. 1, the LED illumination device of the present invention comprises a driving module 10, at least one LED lamp body 20 and at least one power transmission line 30.

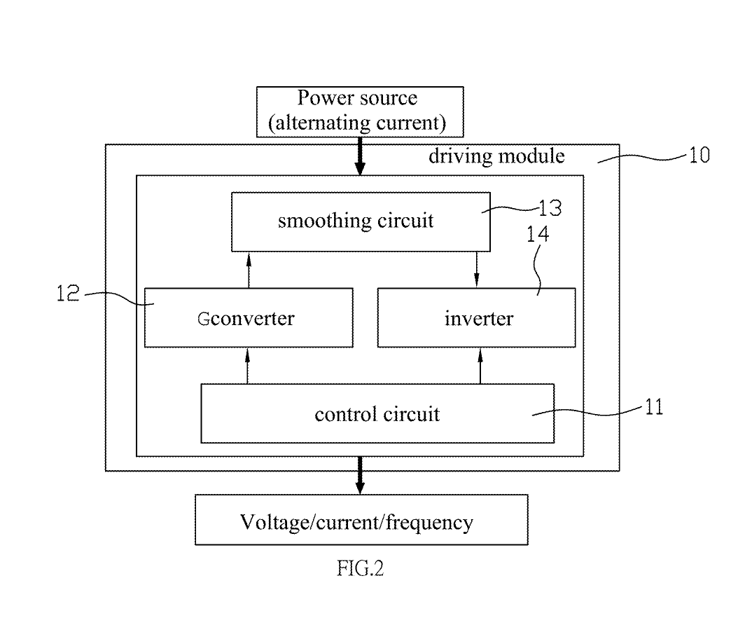

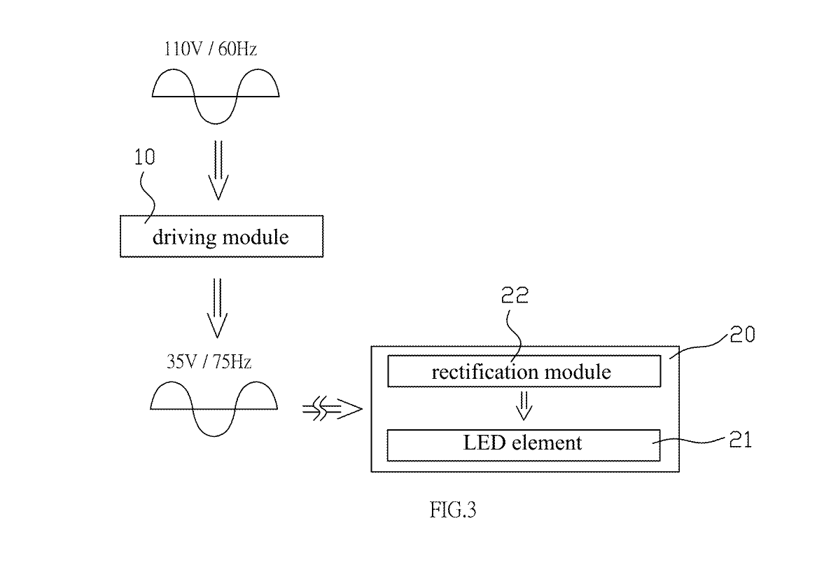

The driving module 10 is used for outputting a high frequency alternating power having above 30 voltages and above 72 Hz frequencies. While in implementation, a control circuit 11, a converter 12, a smoothing circuit 13 and an inverter 14 are integrated in the driving module 10. With reference to FIG. 2 and FIG. 3, alternating current (110V/60 Hz) supplied to the driving module 10 is converted by the converter 12 into direct current, and the direct current then is balanced by the smoothing circuit 13. The direct current is finally inverted by the inverter 14 into another high frequency alternating power (35V/75 Hz) with adjustable frequency.

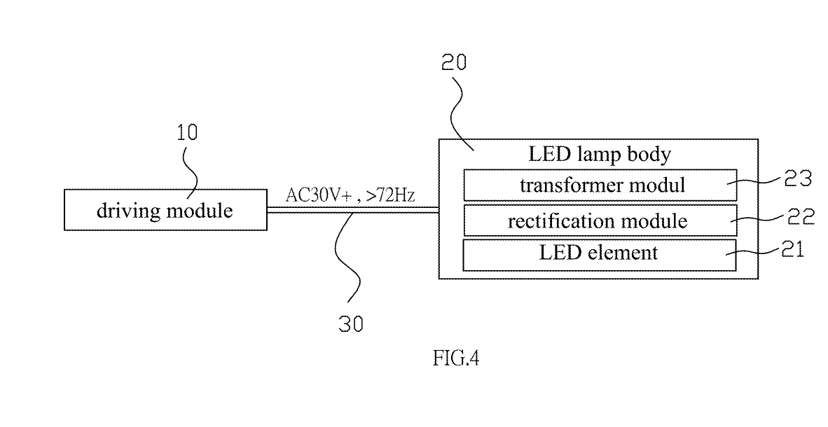

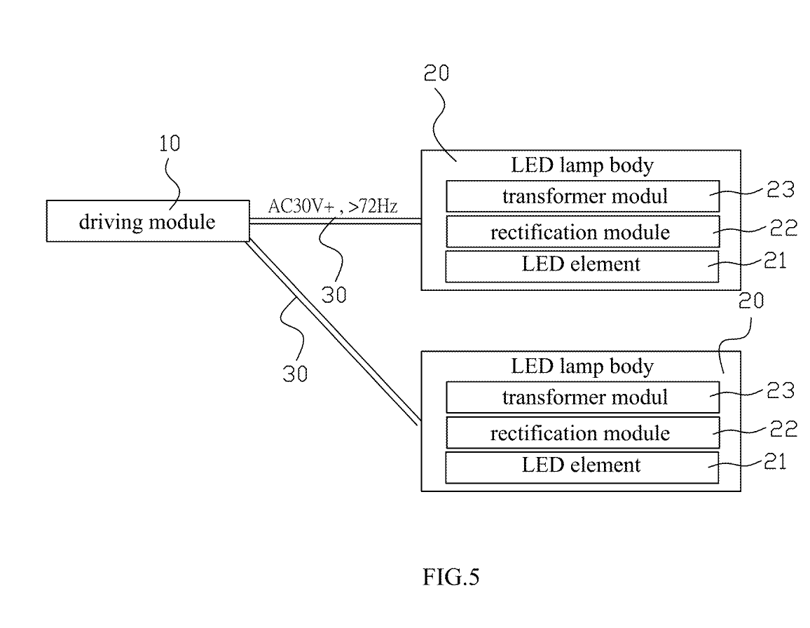

Each LED lamp body 20 has at least one LED element 21 and a rectification module 22. The high frequency alternating power generated from the driving module 10 is modulated by the rectification module 22 into a direct power to drive the at least one LED element 21 for operation. While in implementation, each LED lamp body 20 can be further integrated with a transformer module 23 for boosting or stepping down the high frequency alternating power generated from the driving module 10 as shown in FIG. 4, thereby satisfying the demand of operating the at least one LED element 21. The power transmission line 30 is used to electrically connect the driving module 10 and the at least one LED lamp body 20 so that the driving module 10 can supply the power of operating the at least one LED lamp body 20 disposed to a distal end through the power transmission line 30. As shown in FIG. 5, the driving module 10 can simultaneously supply power to the plurality of LED lamp bodies 20 for operation.

Further, a method for controlling current applied to the LED illumination device comprises the following steps:

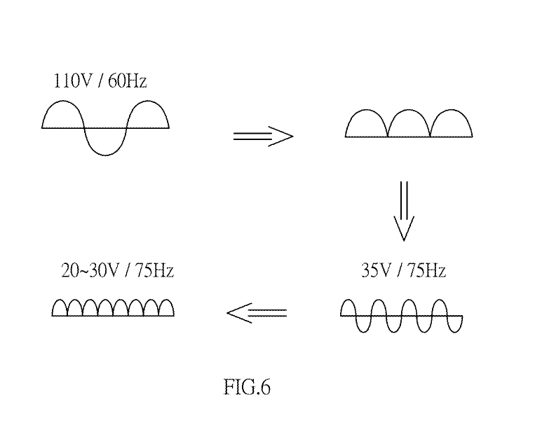

a. The alternating power (the alternating power 119/60 Hz as shown in FIG. 6) is firstly converted into a direct power through frequency modulation. The direct power then is converted into another high frequency alternating power (like 35V/75 Hz as shown in the figure) with adjustable frequencies, wherein this high frequency alternating power has above 30 voltages and above 72 Hz frequencies;

b. The rectification module converts the high frequency alternating power with adjustable frequencies and above 30 voltages and 72 Hz frequencies into a direct power (the direct power in which the voltage is between 20V and 50V and the frequency is 75 Hz as shown in the figure) to drive a light emitting diode element for operation.

The invention mainly takes the high frequency alternating power as a power transmission between the LED lamp bodies and the driving module to drive high power LED elements at long distances. The power consumption resulted from substantial voltage drop on the power transmission lines due to conventional low voltage and high electric current may not be taken place. The light source driven by the high frequency can decrease the flicker phenomenon, and different types of transformers (e.g. the transformer made of piezoelectric materials) can be simultaneously selected to reduce the volume and to enhance the efficiency.

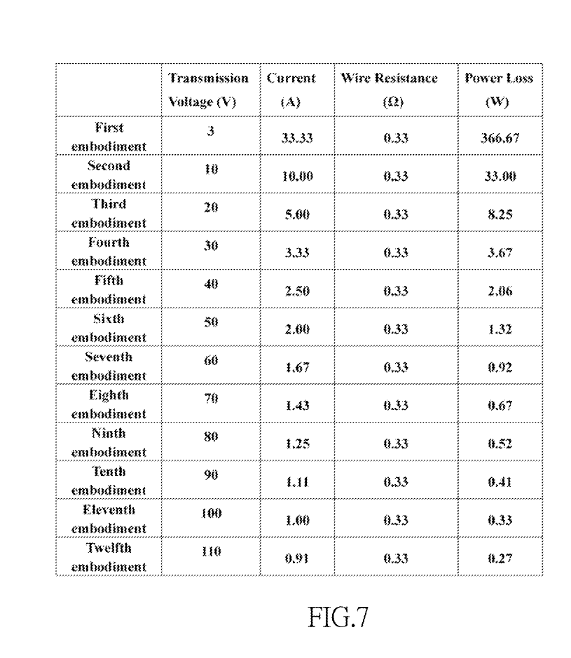

Taking 100 W/20 meters shown FIG. 7 as an example, the consumptions of electric wires are compared under different transmission voltages.

With reference to FIG. 7, when the power transmission line between the LED lamp bodies and the driving module forms a long distance transmission, the transmission voltage is higher, and the power loss is smaller. When the transmission voltage is above 30V (as the fourth embodiment to the twelfth embodiment), the power loss that is smaller than 5 W is acceptable. When the transmission voltage is below 30V (as the first embodiment to the third embodiment), the power loss is really heavy. Consequently, while transmitting power to the high power LED elements, the LED elements may not be driven due to the heavy loss. The power loss on the power transmission lines can be greatly reduced to ensure the operation of the high power LED elements since the transmission voltage is kept at above 30V.

Moreover, the filter component installed inside each LED lamp body can be omitted so that there is no component with relatively lower service life, e.g. active components or capacitors, inside each LED lamp body to greatly enhance the reliability of the LED lamp body. More specifically, a simple circuit is used to reliably drive the LED element to achieve goals of rapidly developing products and saving costs.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A light emitting diode illumination device comprising:
a driving module for outputting high frequency alternating current, wherein a voltage value is above 30v, and a frequency is above 72 Hz;
at least one light emitting diode lamp body having at least one light emitting element and a rectification module, the rectification module modulating the high frequency alternating current generated from the driving module into direct current to drive the at least one light emitting element for operation; and
at least one power transmission line for electrically connecting the driving module and the at least one light emitting diode lamp body.

2. The light emitting diode illumination device as recited in claim 1, wherein the driving module integrates a control circuit, a converter, a smoothing circuit and an inverter therein.

3. The light emitting diode illumination device as recited in claim 1, wherein the light emitting diode lamp body integrates a transformer module for boosting or stepping down the high frequency alternating current generated from the driving module.

4. A method for controlling current of a light emitting diode illumination device, comprising following steps:
a. converting alternating power into a high frequency alternating power having above 30 voltages and above 72 Hz frequencies; and
b. converting the high frequency alternating power into a direct power to drive a light emitting diode element for operation.

5. The method for controlling current of a light emitting diode illumination device as recited in claim 4, wherein a voltage of the direct power is between 20v and 50v.

6. The method for controlling current of a light emitting diode illumination device as recited in claim 4, wherein the step a further comprises a step of firstly converting the alternating power into the direct power, and utilizing frequency modulation to convert the direct power into the high frequency alternating power having above 30 voltages and above 72 Hz frequencies.
